(19) United States
(12) Patent Application Publication
(10) Pub. No.: US 2006/0282599 A1
(43) Pub. Date: Dec. 14, 2006

(54) SLI adaptor card and method for mounting the same to motherboard

(76) Inventor: Yung-Cheng Chiu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/149,293

(22) Filed: Jun. 10, 2005

(51) Int. Cl. G06F 13/36

(52) U.S. Cl. 710/306

(57) ABSTRACT

A method for securely mounting an SLI adaptor card to a motherboard and a motherboard having an SO-DIMM DDR2 memory module connector that can securely adapt an SLI adaptor card. The motherboard has a chip set supporting a PCI-Express interface and an SLI adaptor unit mainly comprising an SO-DIMM DDR2 memory module connector, two PCI-Express slots, a first bus, and a second bus. The SO-DIMM DDR2 memory module connector is for adapting an SLI adaptor card. Each of the two PCI-Express slots is for adapting a graphics card. The first bus and the second bus are, for bridging the chip set, the SO-DIMM DDR2 memory module connector and the two PCI-Express slots. The method comprises the steps of: (1) forming a first bus on the motherboard for bridging a chip set and an SO-DIMM DDR2 memory module connector, wherein the SO-DIMM DDR2 memory module connector has first contacts and second contacts; (2) forming a second bus on the motherboard for bridging the SO-DIMM DDR2 memory module connector and two PCI-Express slots; and (3) soldering the first contacts and the second contacts to the first bus and the second bus respectively.

### TECHNICAL FIELD

This invention relates generally to an SLI adaptor card and method for mounting the same to a motherboard, in particular, to use an SO-DIMM DDR2 memory module connector to connect an SLI adaptor card to a motherboard.

### BACKGROUND OF THE INVENTION

As early as in 1997, the technique of SLI (scalable link interface) has been used to accelerate the imagine display speed of a computer by using one graphics card to depict odd scan lines and using another graphics card to depict even scan lines and then combine the depictions. Recently nVIDIA company has developed a technique using two graphics cards. One of the two graphics card depict the upper half of a picture and another graphics card depict the lower half of the picture. All the depictions are combined in one of the graphics card. The technique of SLI is especially for PCI Express interface. After Intel has developed chip sets that support PCI Express, many motherboard makers and graphics card chip set makers follow the specification of PCI Express.

With reference to FIG. 4 and FIG. 5, a conventional art discloses an SLI connector 91 and a corresponding SLI adaptor card 90. The SLI connector is soldered to a computer motherboard 9 for bridging a chip set and two PCI Express slots (not shown). When the SLI adaptor card 90 is inserted into the SLI connector 91, the computer system is in SLI mode and the two graphics cards that inserted into the two PCI Express slots work in series connection to carry out imagine display functions. When the SLI adaptor card 90 is inserted into the SLI connector 91 in the opposite direction, the computer system is in normal mode and only one of the two graphics cards carry out imagine display functions.

However, the conventional art doesn't provide any additional mechanism to secure the SLI adaptor card 90 to the SLI connector 91 and the SLI adaptor card 90 doesn't tightly fit into the SLI connector 91 as shown in FIG. 4. Hence, motherboard makers have to design extra mechanism(s) to secure the SLI adaptor card 90 to the SLI connector 91 on the motherboard to pass the vibration tests and shock tests. These extra designs increase the manufacturing cost and occupy spaces of the motherboard. In addition, the intervals of the contacts 910 are too small for electric circuit layouts and the noises thereby caused are not easy to control. Therefore, an SLI adaptor card and method for mounting the same to a motherboard that can overcome the above mentioned disadvantages are needed.

### SUMMARY OF INVENTION

It is therefore an objective of the present invention to provide a method for securely mounting an SLI adaptor card to a motherboard and a motherboard having an SO-DIMM DDR2 memory module connector that can securely adapt an SLI adaptor card.

The present invention, briefly summarized, in one embodiment discloses a method for mounting an SLI adaptor card having plural gold fingers to a motherboard and a motherboard that can securely adapt an SLI adaptor card. The method comprises the steps of: (1) forming a first bus on the motherboard for bridging a chip set and an SO-DIMM DDR2 memory module connector, wherein the SO-DIMM DDR2 memory module connector has first contacts and second contacts; (2) forming a second bus on the motherboard for bridging the SO-DIMM DDR2 memory module connector and two PCI-Express slots; and (3) soldering the first contacts and the second contacts to the first bus and the second bus respectively; wherein the dimension of the SLI adaptor card and the gold fingers of the SLI adaptor card fit the SO-DIMM DDR2 memory module connector. The motherboard has a chip set and an SLI adaptor unit. The chip set supports a PCI-Express interface and the SLI adaptor unit mainly comprises an SO-DIMM DDR2 memory module connector, two PCI-Express slots, a first bus, and a second bus. The SO-DIMM DDR2 memory module connector is for adapting an SLI adaptor card. Each of the two PCI-Express slots is for adapting a graphics card. The first bus, is for bridging the chip set and the SO-DIMM DDR2 memory module connector; and The second bus is for bridging the SO-DIMM DDR2 memory module connector and the two PCI-Express slots.

### BRIEF DESCRIPTION OF DRAWINGS

The invention will be more clearly understood after referring to the following detailed description read in conjunction with the drawings wherein:

FIG. 1 is a system diagram of the instant invention;

FIG. 2 is a perspective view of the disassembled SO-DIMM DDR2 memory module connector and the SLI adaptor card of the instant invention;

FIG. 3 is a perspective view of the assembled SO-DIMM DDR2 memory module connector and the SLI adaptor card of the instant invention;

FIG. 4 is a perspective view of the disassembled conventional SLI connector and the SLI adaptor card; and

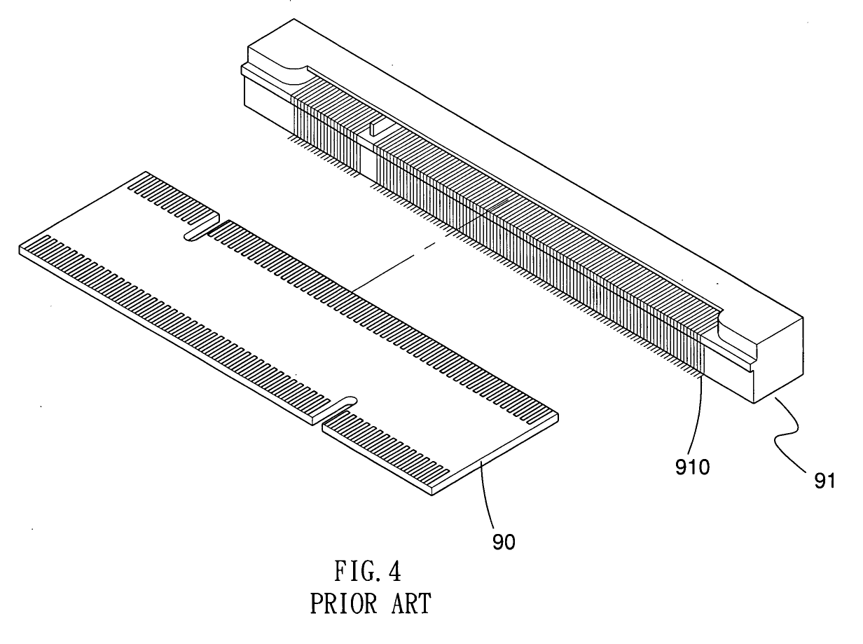

FIG. 5 is a perspective view of the assembled conventional SLI connector and the SLI adaptor card.

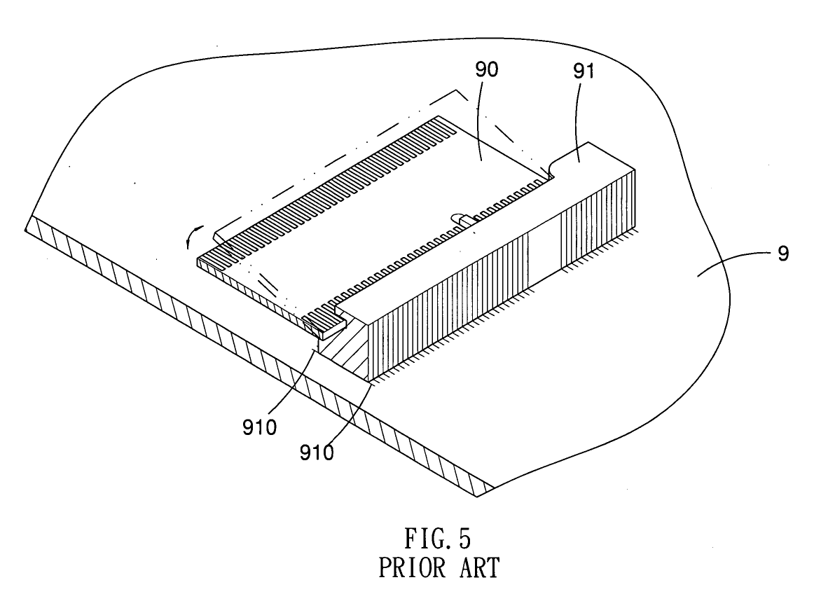

### DETAILED DESCRIPTION OF PREFERRED EMBODIMENTS

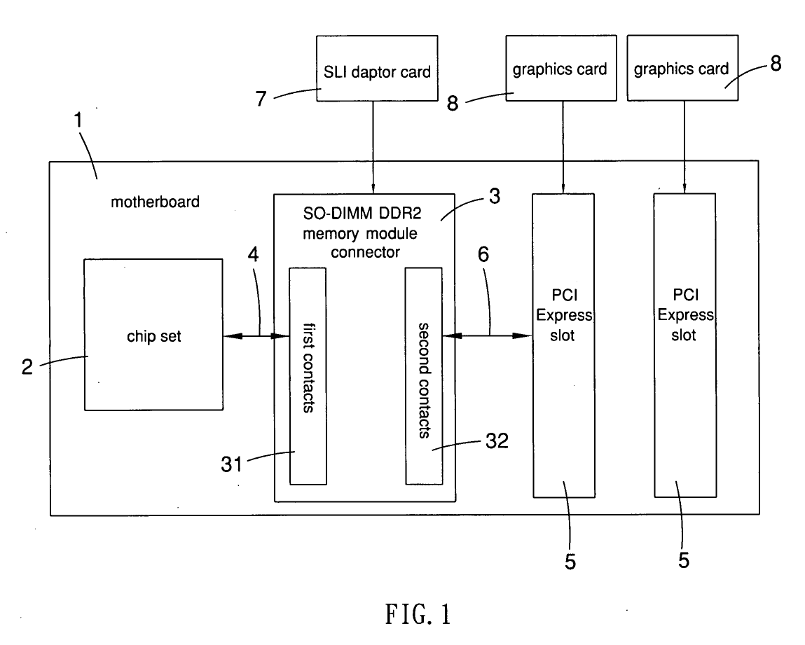

With reference to FIG. 1, the present invention provides a method for mounting an SLI adaptor card 7 having plural gold fingers 70 to a motherboard 1. The method comprises the steps of: (1) forming a first bus 4 on the motherboard 1 for bridging a chip set 2 and an SO-DIMM DDR2 memory module connector 3, wherein the SO-DIMM DDR2 memory module connector 3 has first contacts 31 and second contacts 32; (2) forming a second bus 6 on the motherboard 1 for bridging the SO-DIMM DDR2 memory module connector 3 and two PCI-Express slots 5, wherein each of the PCI-Express slots is for adapting a graphics card 8; and (3) soldering the first contacts 31 and the second contacts 32 to the first bus 4 and the second bus 6 respectively, wherein the dimension of the SLI adaptor card 7 and the gold fingers 70 of the SLI adaptor card 7 fit the SO-DIMM DDR2 memory module connector 3.

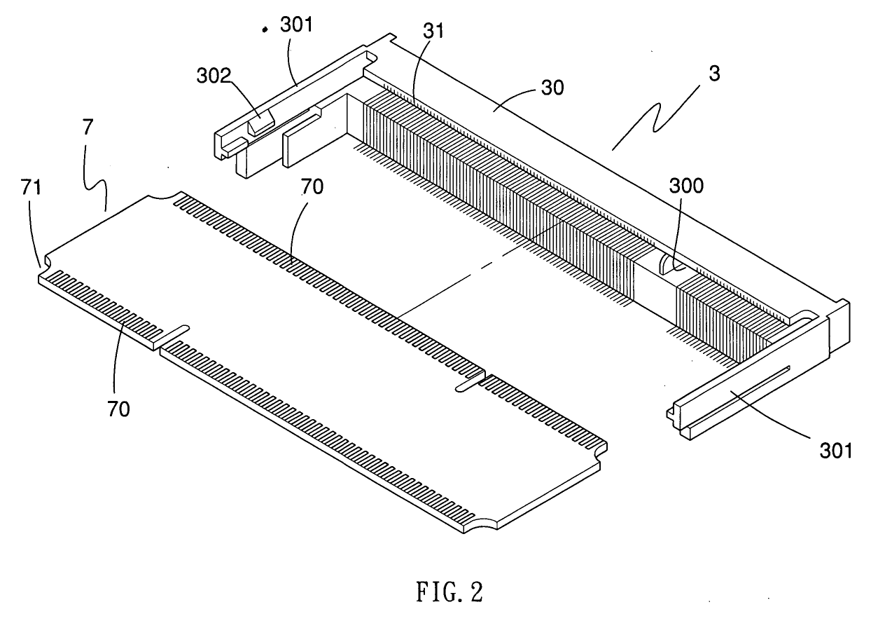

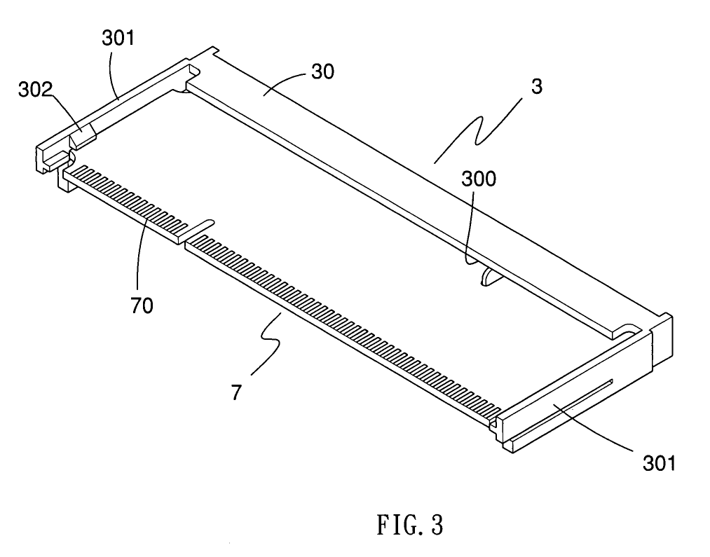

With reference to FIG. 2 and FIG. 3, the SO-DIMM DDR2 memory module connector 3 contains a base 30, a first contacts 31 and a second contacts 32. The base 30 has a slot 300 for receiving the SLI adaptor card 7. Two arms 301 extended from two ends of the base 30 to a distance respectively for retaining two sides of the SLI adaptor card 7. Each of the two arms 301 has a holder 302 for holding the two sides of the SLI adaptor card 7. The first contacts 31 have one lengthwise side installed connected to the slot 300 and another lengthwise side soldered to the first bus 4. The second contacts 32 have one lengthwise side installed connected to the other side of the slot 300 and another lengthwise side soldered to the second bus 4. The first contacts 31 and the second contacts 32 have wide intervals.

With reference to FIG. 2, the dimension, and the shape of the SLI adaptor card 7 and the number, the position, and the interval of the gold fingers 70 of the SLI adaptor card 7 fit a corresponding SO-DIMM DDR2 memory module connector 3. The SLI adaptor card 7 has a shape of rectangular and each corner of the SLI adaptor card 7 forms a gap 71.

The arms 301 and the holder 302 of the SO-DIMM DDR2 memory module connector 3 firmly secure the SLI adaptor card 7 whereby the motherboard 1 can pass the vibration tests and shock tests and without the need of any additional mechanism on the motherboard 1 to secure the SLI adaptor card 7. Hence, the present invention reduces the cost, and save the space of the motherboard 1 and the first contacts 31 and the second contacts 32 has wide intervals to reduce the noises caused thereby.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

We claim:

1. A method for mounting an SLI adaptor card having plural gold fingers to a motherboard, said method comprising:
forming a first bus on said motherboard for bridging a chip set and an SO-DIMM DDR2 memory module connector, said SO-DIMM DDR2 memory module connector having first contacts and second contacts;
forming a second bus on said motherboard for bridging said SO-DIMM DDR2 memory module connector and two PCI-Express slots; and
soldering said first contacts and said second contacts to said first bus and said second bus respectively;
wherein the dimension of said SLI adaptor card and said gold fingers of said SLI adaptor card fit said SO-DIMM DDR2 memory module connector.

2. A motherboard having a chip set and an SLI adaptor unit, said chip set supporting a PCI-Express interface, said SLI adaptor unit comprising:
an SO-DIMM DDR2 memory module connector for adapting an SLI adaptor card;
two PCI-Express slots, each of said two PCI-Express slots being for adapting a graphics card;
a first bus, for bridging said chip set and said SO-DIMM DDR2 memory module connector; and
a second bus for bridging said SO-DIMM DDR2 memory module connector and said two PCI-Express slots.

3. An SLI adaptor card having plural gold fingers, wherein the dimension, and the shape of said SLI adaptor card and the number, the position, and the intervals of said gold fingers of said SLI adaptor card fit a corresponding SO-DIMM DDR2 memory module connector.

4. The SLI adaptor card of claim 3, wherein said SLI adaptor card has a shape of rectangular and each corner of said SLI adaptor card forms a gap.
